(19) United States
(12) Patent Application Publication
(10) Pub. No.: US 2014/0352765 A1
(43) Pub. Date: Dec. 4, 2014

(54) DYE-SENSITIZED SOLAR CELL MODULE, GREENHOUSE, AND BUILDING

(71) Applicant: USHIO DENKI KABUSHIKI KAISHA, Tokyo (JP)

(72) Inventor: Masaki Nakamura, Shizuoka (JP)

(73) Assignee: USHIO DENKI KABUSHIKI KAISHA, Tokyo (JP)

(21) Appl. No.: 14/289,151

(22) Filed: May 28, 2014

(30) Foreign Application Priority Data
May 29, 2013 (JP) 2013-112420

(51) Int. Cl. H01G 9/20

(52) U.S. Cl. CPC H01G 9/2068
USPC 136/251

(57) ABSTRACT

Provided is a dye-sensitized solar cell module that includes: a plurality of cylindrical dye-sensitized solar cells each including a photoelectrode, a counter electrode, an electrolyte layer, and a cylindrical transparent tube, in which the photoelectrode has a dye, the electrolyte layer is provided between the photoelectrode and the counter electrode, and the transparent tube accommodates therein the photoelectrode, the counter electrode, and the electrolyte layer; and one or more frames configured to retain the cylindrical dye-sensitized solar cells at positions that are side-by-side and separated away from one another.

### CROSS REFERENCE TO RELATED APPLICATIONS

This application claims the benefit of Japanese Priority Patent Application JP2013-112420 filed on May 29, 2013, the entire contents of which are incorporated herein by reference.

### BACKGROUND

The invention relates to a dye-sensitized solar cell module, a greenhouse, and a building each including cylindrical dye-sensitized solar cells.

A dye-sensitized solar cell is a solar cell that generates electricity through exciting a dye attached to a surface of a semiconductor by sunlight and injecting electrons released by the excitation into the semiconductor. The dye-sensitized solar cell does not involve use of a vacuum process unlike a crystalline solar cell, a thin-film solar cell, or the like, and thus enables a significant reduction in manufacturing cost. The dye-sensitized solar cell also makes installation cost extremely inexpensive due to its easier transportation and handling. On the other hand, the dye-sensitized solar cell is considered to be disadvantageous in terms of low conversion efficiency; however, a proposal has been made to increase the conversion efficiency by forming the solar cell into a cylindrical shape as a whole, as disclosed in Japanese Patent No. 4840540 and Japanese Unexamined Patent Application Publication Nos. 2003-77550 and 2007-12545. The expectation is therefore placed on practical application of the dye-sensitized solar cell as one of the next-generation solar cells.

### SUMMARY

FIG. 9 schematically illustrates a cross-sectional configuration of a currently-available cylindrical dye-sensitized solar cell. Referring to FIG. 9, a cylindrical dye-sensitized solar cell has a cross-sectional configuration in which a collector electrode 15, a photoelectrode 11, an electrolyte layer 13, and a counter electrode 12 are provided in a cylindrical transparent tube 14. In the configuration, the collector electrode 15 is disposed at an outermost location in the transparent tube 14, the photoelectrode 11 is provided on an inner side of the collector electrode 15, and the electrolyte layer 13 is interposed between the counter electrode 12 disposed in the center of the transparent tube 14 and the photoelectrode 11. The collector electrode 15, the photoelectrode 11, etc., are cylindrical in shape and the counter electrode 12 is columnar in shape, each being coaxial with the transparent tube 14. The collector electrode 15 may be made of a transparent conductive material such as indium tin oxide (ITO). The photoelectrode 11 serves as a work electrode, and has a configuration in which a semiconductor is attached with a dye. The electrolyte layer 13 may be a gel electrolyte layer or a liquid electrolyte layer (electrolytic solution).

The light incident on the transparent tube 14 is transmitted through the collector electrode 15 to excite the dye on the photoelectrode 11, allowing the semiconductor to receive the electrons released by the excitation. The dye having lost the electrons takes the electrons from the electrolyte layer 13 to be reduced. The holes generated in the electrolyte layer 13 receive the electrons at the counter electrode 12. The collector electrode 15 collects charges from the photoelectrode 11 to generate electromotive force between the collector electrode 15 and the counter electrode 12. It is to be noted that the collector electrode 15 may sometimes be provided between the photoelectrode 11 and the electrolyte layer 13. In this case, the collector electrode 15 may be made of a material which is not transparent.

FIGS. 10A-10D schematically illustrate an advantage of the cylindrical dye-sensitized solar cell, in which a state of receiving sunlight by a panel (flat plate) dye-sensitized solar cell is compared with that by the cylindrical dye-sensitized solar cell. FIGS. 10A and 10C each illustrates a case where the sunlight is incident from directly above, whereas FIGS. 10B and 10D each illustrates a case where the sunlight is incident obliquely from above. It is known that the conversion efficiency decreases in the panel dye-sensitized solar cell when the sunlight is incident obliquely (FIG. 10B) as compared with the case when the sunlight is incident vertically (FIG. 10A). In contrast, the cylindrical dye-sensitized solar cell exercises basically the same generation performance in any direction of incidence around 360 degrees, thus making it possible to achieve the conversion efficiency equivalent to that of the vertical incidence (FIG. 10C) even with the oblique incidence (FIG. 10D). Hence, a total amount of power generation in the cylindrical dye-sensitized solar cell per day is higher than that in the panel dye-sensitized solar cell per day when those solar cells are arranged to occupy the same space, since the cylindrical dye-sensitized solar cell is higher in conversion efficiency than the panel dye-sensitized solar cell.

FIG. 11 shows a result of a simulation experiment that confirmed the superiority of the cylindrical dye-sensitized solar cell. In the experiment conducted, a panel dye-sensitized solar cell and a cylindrical dye-sensitized solar cell were fabricated. The panel dye-sensitized solar cell and the cylindrical dye-sensitized solar cell were both made to have the same length as one another, and a width of the panel dye-sensitized solar cell was made the same as a diameter of the cylindrical dye-sensitized solar cell. Configurations of photoelectrode, etc., were made basically the same between those solar cells. In FIG. 11, a vertical axis shows an amount of power generation (in a relative value) per unit time, while a horizontal axis shows time. In this experiment, an amount of power generation per unit time was simulated for each hour from sunrise to sunset on the basis of a solar simulator, where intensity of sunlight was assumed as that around 20th of March in Japan and AM (Air Mass) was 1.5. As is apparent from FIG. 11, the cylindrical dye-sensitized solar cell is larger in amount of power generation than the panel dye-sensitized solar cell overall, and is large in amount of power generation especially in the morning and in the late afternoon where an altitude of the sun is both low.

The cylindrical dye-sensitized solar cell is therefore superior to the panel dye-sensitized solar cell in incidence angle characteristics of the sunlight. The fact that the conversion efficiency becomes lower in the oblique incidence than in the vertical incidence also applies to a crystalline panel solar cell, a thin-film panel solar cell, or the like in general. Hence, the cylindrical dye-sensitized solar cell, which is superior in incidence angle characteristics, is potentially comparable to the crystalline panel solar cell, the thin-film panel solar cell, or the like in terms of a power generation efficiency in total per day (or per year) during which the incidence angle varies in diversity.

However, a research conducted by the inventor revealed that a potential of a currently-available cylindrical dye-sensitized solar cell has not been fully exploited from the viewpoint of conversion efficiency in a module as a whole. When taking the overall module into consideration, there is still room for further improvement in the conversion efficiency of the cylindrical dye-sensitized solar cell.

It is desirable to provide a dye-sensitized solar cell module, a greenhouse, and a building, each capable of further increasing a conversion efficiency of a cylindrical dye-sensitized solar cell.

A dye-sensitized solar cell module according to an embodiment of the invention includes: a plurality of cylindrical dye-sensitized solar cells each including a photoelectrode, a counter electrode, an electrolyte layer, and a cylindrical transparent tube, in which the photoelectrode has a dye, the electrolyte layer is provided between the photoelectrode and the counter electrode, and the transparent tube accommodates therein the photoelectrode, the counter electrode, and the electrolyte layer; and one or more frames configured to retain the cylindrical dye-sensitized solar cells at positions that are side-by-side and separated away from one another.

In one embodiment, the cylindrical dye-sensitized solar cells maybe retained by the single frame. Also, in one embodiment, the following expression may be satisfied: 0.3≦g/φ≦2 where φ is an outer diameter of each of the cylindrical dye-sensitized solar cells, and g is a spacing between one of the cylindrical dye-sensitized solar cells and adjacent one of the cylindrical dye-sensitized solar cells. Further, in one embodiment, the frame may include sockets configured to attachably and detachably retain each of the cylindrical dye-sensitized solar cells at both longitudinal ends of each of the cylindrical dye-sensitized solar cells. Moreover, in one embodiment, the cylindrical dye-sensitized solar cells may have respective lengths that are same as one another, and the frame may be rectangular in shape.

A greenhouse according to an embodiment of the invention includes: a housing; a light introducing part provided entirely or partially on the housing; a dye-sensitized solar cell module provided to face the light introducing part, and including a plurality of cylindrical dye-sensitized solar cells and one or more frames, in which the cylindrical dye-sensitized solar cells each include a photoelectrode, a counter electrode, an electrolyte layer, and a cylindrical transparent tube, the photoelectrode has a dye, the electrolyte layer is provided between the photoelectrode and the counter electrode, and the transparent tube accommodates therein the photoelectrode, the counter electrode, and the electrolyte layer, and in which the frame is configured to retain the cylindrical dye-sensitized solar cells at positions that are side-by-side and separated away from one another; and a growth module configured to utilize electricity generated by the cylindrical dye-sensitized solar cells for growth of a plant in the greenhouse. As used herein, the term “housing” refers to a structure that defines inside and outside of the greenhouse, and may include, without limitation, a roof and a wall.

In one embodiment, a longitudinal direction of each of the cylindrical dye-sensitized solar cells in the dye-sensitized solar cell module may be in a vertical direction. Also, in one embodiment, the greenhouse may further include a long-hour light source provided therein, and the growth module may include: an electricity storage configured to store therein the electricity generated by the dye-sensitized solar cell module; and a controller configured to supply the electricity stored in the electricity storage to the long-hour light source before sunrise, after sunset, or both, to allow the long-hour light source to be ON.

A building according to an embodiment of the invention includes: a housing; and a plurality of cylindrical dye-sensitized solar cells provided entirely or partially on the housing, and provided side-by-side and separated away from one another. A longitudinal direction of each of the cylindrical dye-sensitized solar cells is in a vertical direction. As used herein, the term “housing” refers to a structure that defines inside and outside of the building, and may include, without limitation, a roof and a wall.

According to the dye-sensitized solar cell module in the above-described embodiment of the invention, the plurality of cylindrical dye-sensitized solar cells are provided side-by-side and separated away from one another, making it possible to increase conversion efficiency. Also, sunlight is allowed to pass through a clearance between the cylindrical dye-sensitized solar cells. Hence, the dye-sensitized solar cell module may be suitably arranged on a roof, a wall, or the like of a building that requires introduction of light into the inside. Further, in the presence of scattered light behind the dye-sensitized solar cell module, power generation is achieved also by the scattered light entering from the behind, which makes it possible to further increase the conversion efficiency.

In one embodiment where the cylindrical dye-sensitized solar cells are retained by the single frame, it is also possible to achieve effects that transportation and installation of the dye-sensitized solar cell module become easier. Also, in one embodiment where the frame includes the sockets configured to attachably and detachably retain each of the cylindrical dye-sensitized solar cells at the both longitudinal ends of each of the cylindrical dye-sensitized solar cells, it is also possible to achieve effects that maintenance operation is facilitated and costs associated with the maintenance are less expensive. Further, in one embodiment where the cylindrical dye-sensitized solar cells have the respective lengths that are same as one another, and the frame is rectangular in shape, it is also possible to achieve effects that the dye-sensitized solar cell module is able to make full use of rectangular empty space.

According to the greenhouse in the above-described embodiment of the invention, the electricity generated by the dye-sensitized solar cell module covers the electricity used by the growth module, making it possible to save money on electricity. In addition, the cylindrical dye-sensitized solar cells are separated away from one another in the dye-sensitized solar cell module and thus sunlight is allowed to pass through a clearance between the cylindrical dye-sensitized solar cells. Hence, it is possible to introduce enough amount of sunlight to plants at the inside by appropriately setting a separation spacing. Also, in one embodiment where the longitudinal direction of each of the cylindrical dye-sensitized solar cells in the dye-sensitized solar cell module is in the vertical direction, it is also possible to achieve effects that attachment of stain or accumulation of dust is advantageously suppressed. Further, in one embodiment where the growth module is configured to perform a long-day adjustment, it is also possible to achieve effects that preferable growing of long-day plants is achievable.

According to the building in the above-described embodiment of the invention, the plurality of cylindrical dye-sensitized solar cells are so provided side-by-side and separated away from one another that the longitudinal direction of each of the cylindrical dye-sensitized solar cells is in the vertical direction, making it possible to increase conversion efficiency. In addition, it is possible to make stain or dust difficult to accumulate and to make a decrease in conversion efficiency caused by stain or dust difficult to occur.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the invention.

FIG. 1 is a schematic perspective view illustrating a dye-sensitized solar cell module according to an embodiment of the invention.

FIGS. 2A and 2B are schematic cross-sectional views illustrating a cylindrical dye-sensitized solar cell included in the dye-sensitized solar cell module according to the example embodiment, in which FIG. 2A is a schematic cross-sectional view taken along a plane perpendicular to a longitudinal direction of the cylindrical dye-sensitized solar cell, and FIG. 2B is a schematic cross-sectional view taken along a plane in the longitudinal direction thereof.

FIG. 3 is a schematic cross-sectional view illustrating a retaining structure of the cylindrical dye-sensitized solar cell in the dye-sensitized solar cell module according to the example embodiment.

FIG. 4 is a schematic cross-sectional view of the dye-sensitized solar cell module according to the example embodiment, taken along a plane perpendicular to the longitudinal direction of each of the cylindrical dye-sensitized solar cells.

FIGS. 5A-5D schematically illustrate an advantage of the dye-sensitized solar cell module according to the example embodiment.

FIG. 6 is a schematic cross-sectional view illustrating an example of installation of the dye-sensitized solar cell module according to the example embodiment.

FIG. 7 is a schematic front view illustrating a greenhouse according to an embodiment of the invention.

FIG. 8 illustrates a schematic configuration of a growth module included in the greenhouse according to the example embodiment.

FIG. 9 schematically illustrates a cross-sectional configuration of a currently-available cylindrical dye-sensitized solar cell.

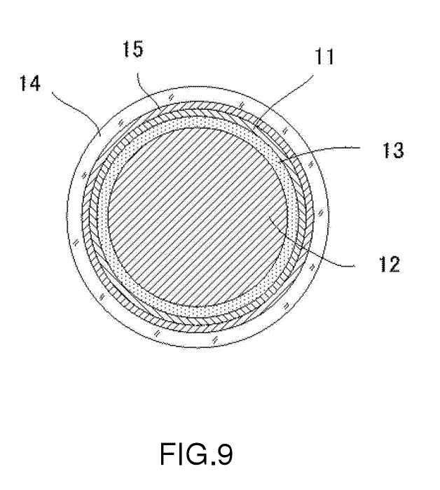

FIGS. 10A-10D schematically illustrate an advantage of a cylindrical dye-sensitized solar cell, in which a state of receiving sunlight by a panel (flat plate) dye-sensitized solar cell is compared with that by the cylindrical dye-sensitized solar cell.

FIG. 11 shows a result of a simulation experiment that confirmed the superiority of the cylindrical dye-sensitized solar cell.

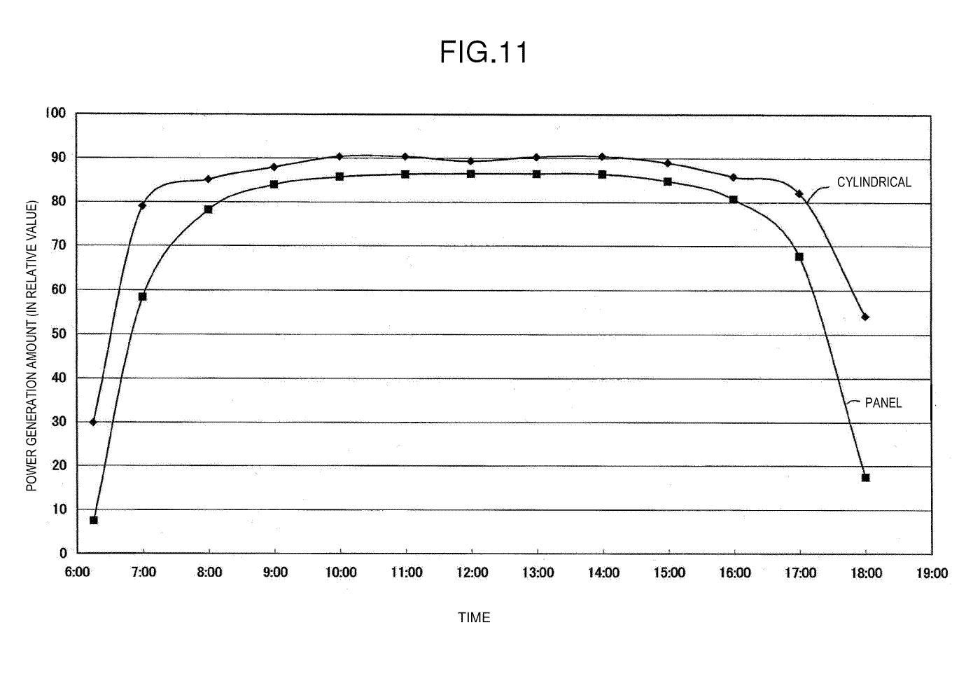

### DETAILED DESCRIPTION

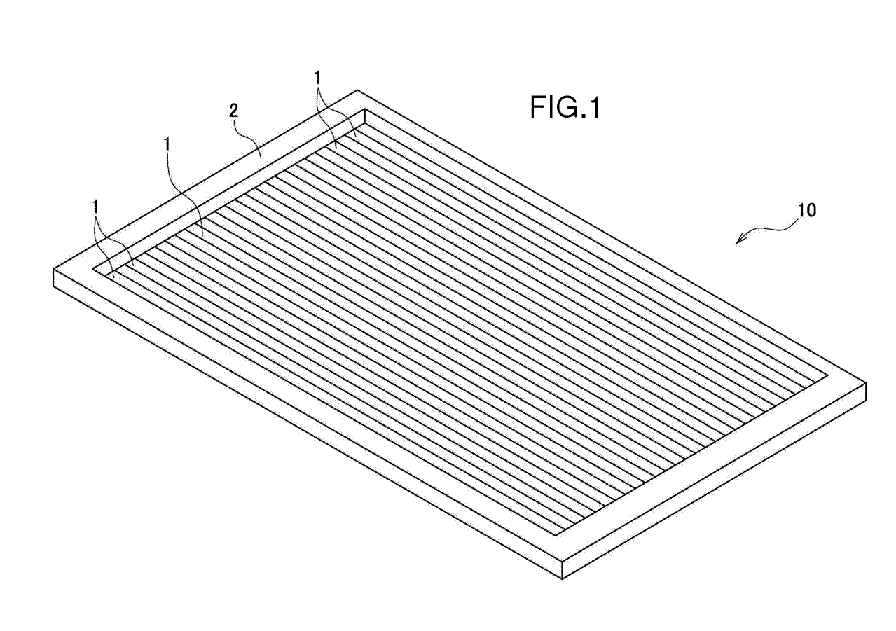

Some embodiments of the invention are described in detail below with reference to the accompanying drawings. FIG. 1 is a schematic perspective view of a dye-sensitized solar cell module 10 according to an embodiment of the invention. Referring to FIG. 1, the dye-sensitized solar cell module 10 includes a plurality of cylindrical dye-sensitized solar cells 1. In the following, each of the cylindrical dye-sensitized solar cells 1 is simply referred to as a “cylindrical cell 1”.

As illustrated in FIG. 1, the plurality of cylindrical cells 1 are arranged laterally in a side-by-side fashion. In the present embodiment, the cylindrical cells 1 may be so arranged that the respective longitudinal directions (axial directions of the cylinders) thereof are substantially parallel to one another. The plurality of cylindrical cells 1 may be retained by a single frame 2. The frame 2 may be rectangular in shape as illustrated in FIG. 1, and a direction of one side of the rectangular shape may correspond to the longitudinal direction of each of the cylindrical cells 1.

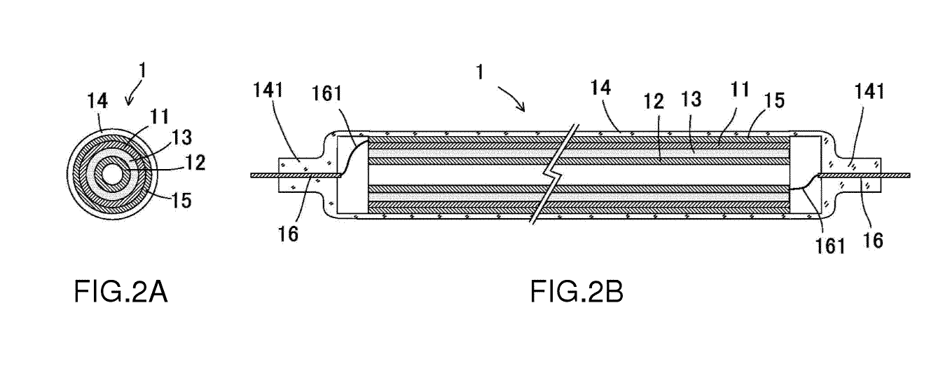

FIGS. 2A and 2B are schematic cross-sectional views of the cylindrical cell 1, in which FIG. 2A is a schematic cross-sectional view taken along a plane perpendicular to the longitudinal direction of the cylindrical cell 1, and FIG. 2B is a schematic cross-sectional view taken along a plane in the longitudinal direction thereof. Referring to FIGS. 2A and 2B, the cylindrical cell 1 has a configuration in which a photoelectrode 11, a counter electrode 12, and an electrolyte layer 13 are provided inside a cylindrical transparent tube 14. The photoelectrode 11 has a dye, and the electrolyte layer 13 is interposed between the photoelectrode 11 and the counter electrode 12. Further, a collector electrode 15 is provided inside the transparent tube 14 at an outer side of the photoelectrode 11.

The transparent tube 14 may be made of silica glass in the present embodiment. Alternatively, the transparent tube 14 may be made of any other material such as borosilicate glass or soda glass. The photoelectrode 11 has a configuration in which the dye is attached to a semiconductor. The semiconductor may preferably be an n-type semiconductor, and may be made of a material such as a metal oxide or a metal sulfide. Examples of the metal oxide may include a titanium oxide and a tin oxide. The metal sulfide may be zinc sulfide. The dye may be any dye without particular limitation as long as the dye absorbs light from a visible range to an infrared range. Examples of such a dye may include an organic dye and a metal complex. More specific but non-limiting examples of the dye may include: a cyanine-based dye such as merocyanine, quinocyanine, or criptocyanine; and a metal complex such as copper, ruthenium, osmium, iron, or zinc.

The electrolyte layer 13 may be a liquid electrolyte layer in this embodiment, and may be an iodine-based electrolyte layer, a bromine-based electrolyte layer, or the like. The electrolyte layer 13 is enclosed in the transparent tube 14 at an amount by which at least a region between the photoelectrode 11 and the counter electrode 12 is filled. The counter electrode 12 is made of a conductive material, and may be preferably high in corrosion resistance to a material of the electrolyte layer 13. For example, the counter electrode 12 may be made of a material such as titanium or platinum. In the present embodiment, the counter electrode 12 may be cylindrical in shape. As illustrated in FIG. 2A, the respective members are coaxial with the transparent tube 14, being disposed in the order of the counter electrode 12, the photoelectrode 11, and the collector electrode 15 from the center. The collector electrode 15 may be made of an existing transparent conductive material such as indium tin oxide (ITO). It is to be noted that a configuration may be permitted in theory where the collector electrode 15 is omitted as long as extraction of charges is possible only with use of the photoelectrode 11. The collector electrode 15 may be formed by providing a transparent conductive film on the transparent tube 14 using a method such as wet coating. The photoelectrode 11 may be formed by depositing semiconductor microparticles attached with the dye or sintering such microparticles, and may preferably have a porous structure. For forming methods and manufacturing methods of the respective members other than those described above, reference is made to Japanese Patent No. 4840540 and Japanese Unexamined Patent Application Publication Nos. 2003-77550 and 2007-12545.

As illustrated in FIG. 2B, both ends of the transparent tube 14 are sealed by a pair of sealing sections 141. The pair of sealing sections 141 serve to prevent leakage of the electrolyte layer 13 which may be in a form of liquid, and prevent harmful substances such as water and air (oxygen) from entering inside the transparent tube 14. The pair of sealing sections 141 may be formed through heating the both ends of the transparent tube 14 and squashing the both ends with application of pressure (pressure crushing) under a state in which the both ends are softened. For the detail on the sealing, reference is made to Japanese Patent No. 4840540 and description thereof is omitted herein.

The sealing is performed with respective leads 16 being inserted through the both ends, whereby the pair of sealing sections 141 provide air-tightness and liquid-tightness in a state in which the respective leads 16 penetrate therethrough. Each of the leads 16 may have a rod-like shape in the present embodiment. Alternatively, the leads 16 each may be a wire-like lead, or may be a member in which two rod-like conductors or wire-like conductors are coupled to each other through a metal foil (see Japanese Patent No. 4840540). The leads 16 on the respective ends of the transparent tube 14 serve to take out electricity generated inside the transparent tube 14, one of which being connected to the counter electrode 12 through a conducting wire 161 and the other being connected to the collector electrode 15 as illustrated in FIG. 2B. It is to be noted that, although unillustrated, one of the leads 16 is connected to the counter electrode 12 through a rod section so as to serve also as a retainer of the counter electrode 12 in the transparent tube 14.

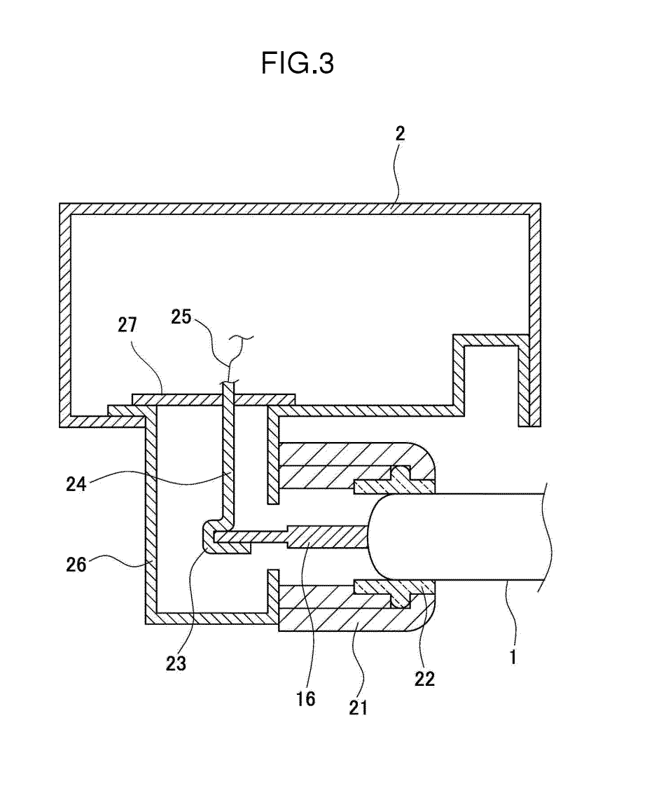

FIG. 3 is a schematic cross-sectional view illustrating a retaining structure of the cylindrical cell 1 in the dye-sensitized solar cell module 10 according to the present embodiment. The frame 2 may be rectangular in shape, and may retain both ends of the cylindrical cell 1 by two opposing sides thereof as illustrated in FIG. 1. Although FIG. 3 illustrates the retaining structure in one of the sides of the frame 2, the same retaining structure applies to the opposing side thereof. Referring to FIG. 3, one side of the frame 2 may have a cross-section in a shape of an alphabet “U” substantially with an opening formed by such a cross-sectional shape facing downward. The downside of the frame 2 may be provided with a socket 21. The socket 21 is fixed to the frame 2 through a socket base 26.

The socket 21 is a substantially cylindrical member, and is retained by the socket base 26 with an axial direction thereof facing toward the other one side of the frame 2. One end of the socket 21 has a slightly decreased inner diameter to allow an end of the cylindrical cell 1 to be inserted and retained thereat. For convenience of description, a side on which the cylindrical cell 1 is located in the socket 21 is referred to as “inner side” and a side opposite thereto in the socket 21 is referred to as “outer side”.

As illustrated in FIG. 3, the socket 21 has a packing 22 on an inner surface of the end at which the cylindrical cell 1 is retained. The packing 22 has an inner diameter slightly larger than an outer diameter of the end of the transparent tube 14 in the cylindrical cell 1. Thus, the packing 22 is slightly compressed when the end of the transparent tube 14 is inserted thereto as illustrated in FIG. 3, providing air-tightness and liquid-tightness. It is to be noted that an O-ring may be provided instead of the packing 22, or in addition to the packing 22. The outer side of the socket 21 is provided with a connector terminal 23 for bringing the retained cylindrical cell 1 into electrical conduction. A tip of the lead 16 has a thin rod-like shape, and is exposed from the sealing section 141 and extending therefrom. The connector terminal 23 is a member into which the tip of the lead 16 is inserted, i.e., is a member so bent as to form a narrow depression. The tip of the lead 16 is so inserted into the connector terminal 23 as to enlarge an opening formed by the depression outward in a pressing fashion.

Also, the connector terminal 23 is provided with a plate spring section 24 as illustrated in FIG. 3. In other words, the connector terminal 23 has a bent section into which the tip of the lead 16 is inserted at a lower end thereof, and a plate shaped portion extending upward from the bent section as the plate spring section 24. The plate spring section 24 has an upper section fixed to the socket base 26 through an insulating member 27. An upper end of the plate spring section 24 is connected to a conducting wire 25. The conducting wire 25 is connected to an unillustrated output terminal that serves to take out electricity from the dye-sensitized solar cell module 10.

In the retaining structure of the cylindrical cells 1 described above, the cylindrical cells 1 may be provided attachably and detachably. When attaching the cylindrical cell 1, one of the ends of the cylindrical cell 1 is inserted into corresponding one of the sockets 21 from the inner side of that socket 21, and the tip of corresponding one of the leads 16 is inserted into corresponding one of the connector terminals 23. Then, that connector terminal 23 is slightly pressed with the cylindrical cell 1 to insert the other end of the cylindrical cell 1 into the other socket (not illustrated in FIG. 3). Thereafter, elasticity of the plate spring section 24 of one of the connector terminals 23 is utilized to move the cylindrical cell 1 toward the other connector terminal to insert a tip of the other lead 16 into the other connector terminal. This brings the attachment of the cylindrical cell 1 to completion.

A separation spacing in a free state between the pair of connector terminals 23 is made slightly narrower than an overall length of the cylindrical cell 1 (i.e., a length between the tips of the respective leads 16 on both sides), allowing each of the connector terminals 23 to be pressed against the corresponding tip of the lead 16 by the elasticity of the plate spring section 24 and thereby establishing electrical conduction when the attachment is completed. The removal of the cylindrical cell 1 is performed in an opposite manner to that of the attachment, i.e., the cylindrical cell 1 as a whole is slightly moved toward one of the sides against the elasticity of the plate spring section 24 in the connector terminal 23 to pull out from the socket 21 the end of the cylindrical cell 1 on the other side. This removes the tip of the lead 16 on the other side from the connector terminal 23. Then, the end of the cylindrical cell 1 on one side is pulled out from the socket 21 while slightly lowering the end on the other side to tilt the cylindrical cell 1 as a whole. This removes the tip of the lead 16 on one side from the connector terminal 23.

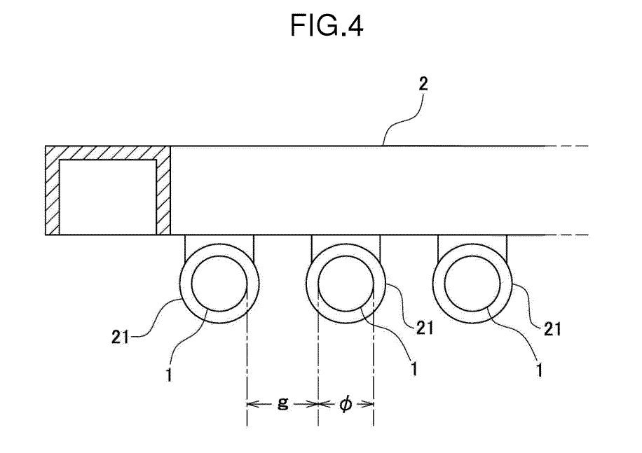

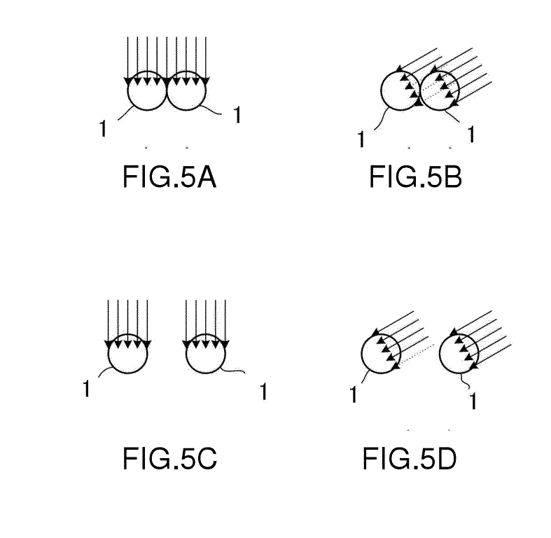

FIG. 4 is a schematic cross-sectional view of the dye-sensitized solar cell module 10 according to the present embodiment, taken along a plane perpendicular to the longitudinal direction of each of the cylindrical cells 1. In the dye-sensitized solar cell module 10 according to the present embodiment, the plurality of cylindrical cells 1 are arranged laterally in a side-by-side fashion, but are not in contact with one another to provide a space between the transparent tubes 14, as illustrated in FIGS. 1 and 4. This feature makes it possible to further utilize characteristics of the cylindrical cell 1 and to further increase conversion efficiency thereof, a description of which is provided below with reference to FIGS. 5A-5D.

FIGS. 5A-5D schematically illustrates an advantage of the dye-sensitized solar cell module 10 according to the present embodiment. FIGS. 5C and 5D each illustrates the dye-sensitized solar cell module 10 according to the present embodiment, in which the cylindrical cells 1 are provided side-by-side laterally and separated away from one another. FIGS. 5A and 5B each illustrates a comparative example, in which the cylindrical cells 1 are provided side-by-side laterally and brought into contact with one another. FIGS. 5A and 5C each illustrates a case where the sunlight is incident from directly above, or where the cylindrical cells 1 are so arranged that the respective longitudinal directions thereof are vertical as seen from the front and the sun is on the meridian. FIGS. 5B and 5D each illustrate a case where the sunlight is incident obliquely on each of the cylindrical cells 1. In each of FIGS. 5B and 5D, a case may be assumed where the cylindrical cells 1 are so arranged that the respective longitudinal directions thereof are horizontal as seen from the front, or where the cylindrical cells 1 are so arranged that the respective longitudinal directions thereof are vertical as seen from the front and the sun is at any position other than the meridian.

When the sunlight is incident from directly above (or in the case where the cylindrical cells 1 are vertically arranged and the sun is at the meridian), an amount of sunlight incident on each of the cylindrical cells 1 and utilized for power generation does not vary virtually in either case of the contact arrangement illustrated in FIG. 5A or the separated arrangement illustrated in FIG. 5C. When the sunlight, however, is incident obliquely, part of the sunlight is blocked by the adjacent cylindrical cell 1 in the contact arrangement as illustrated in FIG. 5B. In contrast, in the separated arrangement, blocking by the adjacent cylindrical cell 1 is prevented from occurring or hardly occurs. Hence, the amount of sunlight utilized for the power generation is greater in the separated arrangement than in the contact arrangement. The arrows arrayed at equal intervals in FIGS. 5A-5D schematically denote the incident amount of sunlight. For example, when assuming that an amount of sunlight that enters a region corresponding to a diameter of the single cylindrical cell 1 is defined by five arrows, the amount of sunlight that enters the two cylindrical cells 1 may be that corresponding to seven arrows due to the blocking, when the sunlight is incident obliquely in the contact arrangement illustrated in FIG. 5B. In contrast, the amount of sunlight that enters the two cylindrical cells 1 may be that corresponding to nine arrows in the separated arrangement, for example.

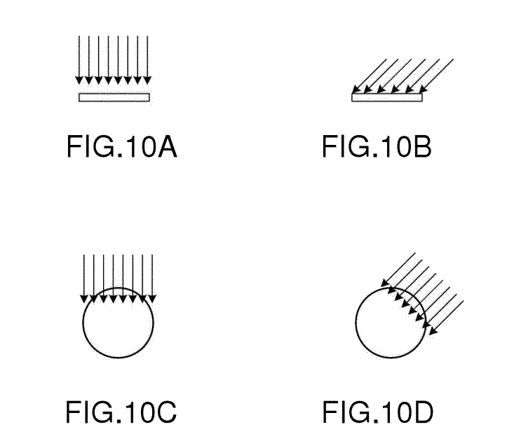

The states illustrated in FIGS. 5A and 5C are exceptional and in most cases, the sunlight is incident obliquely on the cylindrical cells 1. Hence, the configuration according to the present embodiment that adopts the separated arrangement is superior in that high conversion efficiency is achieved in most cases. The conversion efficiency here refers to a conversion efficiency based upon a comparison between the contact arrangement and the separated arrangement, per cylindrical cell 1. Note that, as is apparent from a comparison between FIGS. 10A-10D and FIG. 5D, although an incident amount of sunlight does not vary substantially between the panel dye-sensitized solar cell and the cylindrical cells 1 having the separated arrangement when the comparison is made per specific region, the conversion efficiency is higher in the cylindrical cells 1 having the separated arrangement, since an amount of light that enters the photoelectrode 11 at right angle or at an angle near thereto is larger in the cylindrical cells 1 having the separated arrangement.

In the configuration of the separated arrangement described above, a separation spacing between the cylindrical cells 1 (denoted by “g” in FIG. 4) is important in terms of a relationship between an occupying space and the conversion efficiency. If the separation spacing g is decreased to the extent equal to or over the limit, an amount of sunlight blocked by the adjacent cylindrical cell 1 may be increased, which may make it difficult to achieve sufficient effects derived from the increase in the conversion efficiency. On the other hand, increasing the separation spacing g to the extent equal to or over the limit may hardly achieve effects derived from the increase in the conversion efficiency any further, and may only result in an increase in occupying space of the dye-sensitized solar cell module 10. Hence, the separation spacing g may preferably be that defined by the expression: 0.3φ≦g≦2φ where an outer diameter of the cylindrical cell 1 is φ, and more preferably be that defined by the expression: 1.0φ≦g≦1.5φ.

As described above, the configuration in which the cylindrical cells 1 are each arranged at a distance contributes to the improvement in the conversion efficiency from another perspective, a description of which is provided below. The configuration in which the cylindrical cells 1 are each arranged at a distance according to the present embodiment allows the sunlight to pass through a clearance between the cylindrical cells 1. This means that the light is not completely blocked by the dye-sensitized solar cell module 10 even when the dye-sensitized solar cell module 10 is installed. Such a feature greatly differs from that of a panel dye-sensitized solar cell module currently available.

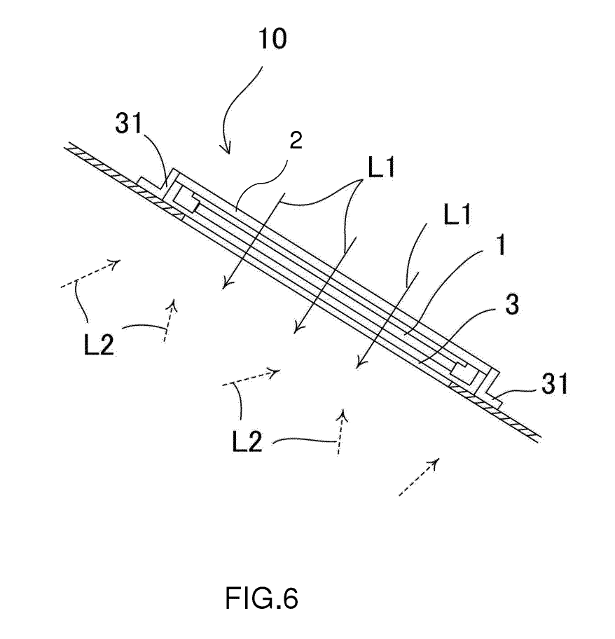

Considering utilization of the feature where the light is allowed to pass partially, the dye-sensitized solar cell module 10 according to the present embodiment may be preferably arranged on a roof or on a wall that requires introduction of light. Examples of arrangement may include installation on a roof or a wall of a greenhouse such as a plastic greenhouse or a conservatory, and installation on an opening or a window directed to introduction of light, such as that in an office building or a residence. FIG. 6 schematically illustrates an example of installation of the dye-sensitized solar cell module 10. In one installation example, a building includes a light introducing part 3 on a roof or on a wall thereof. The light introducing part 3 may be a light transmissive sheet, a light transmissive plate, a window, or the like. The dye-sensitized solar cell module 10 according to the present embodiment may be so attached on a roof or a wall that the light introducing part 3 is located in the rear of the dye-sensitized solar cell module 10. For example, the dye-sensitized solar cell module 10 may be attached on the roof or the wall by fixing the frame 2 to the roof or the wall through a fixing member 31.

Referring to FIG. 6, when the dye-sensitized solar cell module 10 according to the present embodiment is so disposed that the light introducing part 3 for the interior is located in the rear of the dye-sensitized solar cell module 10, part of sunlight (partial sunlight L1) passes through the clearance between the cylindrical cells land is transmitted through the light introducing part 3 to reach the interior. The light having reached the interior is scattered in the interior, and part of the scattered light L2 is transmitted through the light introducing part 3 again to return to the dye-sensitized solar cell module 10. The scattered light L2 having returned to the dye-sensitized solar cell module 10 enters the backside of each of the cylindrical cells 1 to be utilized for power generation. In particular, it is known that a dye-sensitized solar cell is capable of generating power even with weak light, and thus the dye-sensitized solar cell module 10 according to the present embodiment utilizes such characteristics of the dye-sensitized solar cell in this respect as well. It is to be noted that the separation spacing g for each of the cylindrical cells 1 may be set at a value that is equal to or greater than the limit discussed above, in terms of increased introduction of light.

As illustrated in FIGS. 5A and 5B, the power generation derived from the light that enters from the backside as described above is virtually unobtainable when the cylindrical cells 1 are arranged to contact with one another. This is because the sunlight is entirely blocked by a dye-sensitized solar cell module virtually in the configuration illustrated in FIGS. 5A and 5B. The dye-sensitized solar cell module 10 according to the present embodiment makes possible the installation on a roof or on a wall of a building that requires the introduction of light by so arranging the cylindrical cells 1 as to be separated from one another. In addition thereto, since the light having passed through the clearance between the cylindrical cells 1 is scattered in the interior and eventually returns to the dye-sensitized solar cell module 10 as returned light, it is also possible for the dye-sensitized solar cell module 10 according to the present embodiment to utilize the returned light to further improve the conversion efficiency consequently.

Also, in one embodiment, each of the cylindrical cells 1 may be retained by the sockets 21 and may be thus attachably and detachably provided. This makes it possible to improve ease of maintenance. More specifically, when any one of the cylindrical cells 1 needs replacement due to deterioration, failure, or other troubles, this allows for replacement of the cylindrical cell 1 by removing only that cylindrical cell 1, and therefore does not require replacement of the entire dye-sensitized solar cell module 10. Hence, it is possible to achieve easier maintenance operation and to make the costs associated with the replacement less expensive.

Further, in one embodiment, each of the cylindrical cells 1 may be retained by the single frame 2. This has significance in that transportation and installation of the dye-sensitized solar cell module 10 are made easier. More specifically, retaining the cylindrical cells 1 with the frame 2 allows each of the cylindrical cells 1 to be moved or transported integrally. In addition, fixing the frame 2 to a predetermined location also completes the installation of each of the cylindrical cells 1 to that predetermined location. Hence, the transportation and the installation are easy, which further highlights the superiority of the dye-sensitized solar cell module 10. As used herein, the wording “the single frame” means that the frame is single from the viewpoint that the plurality of cylindrical cells 1 are movable or transportable integrally, and may encompass a situation where the single frame 2 is formed by coupling a plurality of members.

Moreover, in one embodiment, the cylindrical cells 1 may all have the same length as one another, and the frame 2 may be rectangular in shape. This has significance in that space available on a roof or on a wall of a building is utilizable efficiently. More specifically, empty rectangular space is often reserved on a roof such as a gabled roof as the space for installation of a solar cell module. Hence, in one embodiment where the dye-sensitized solar cell module 10 retains the cylindrical cells 1 integrally by the rectangular frame 2, it is possible to make full use of the empty space and to allow a larger region to be utilized as the space for solar power generation.

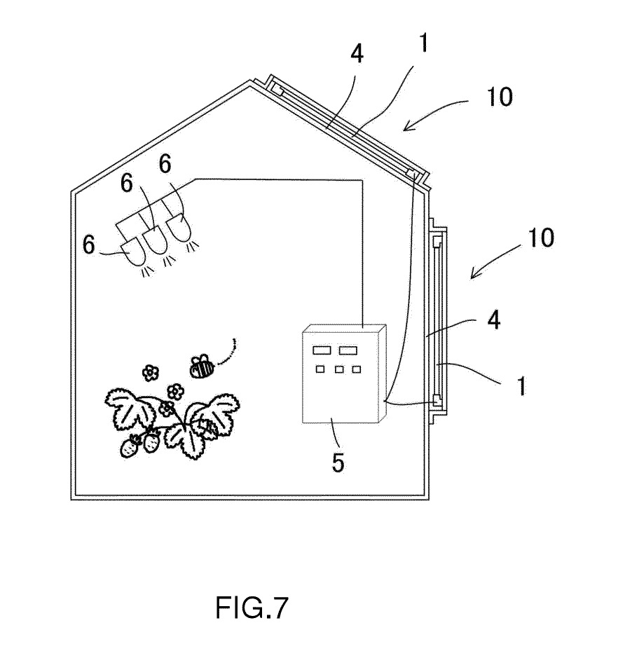

Next, a greenhouse according to an embodiment of the invention is described. FIG. 7 is a schematic front view of a greenhouse according to one embodiment. The greenhouse according to the present embodiment may be a building in which plants are grown such as a plastic greenhouse or a conservatory. Typically, a roof or a wall of a greenhouse serves as a light introducing part as a whole, and such a light introducing part may be typically a plastic sheet, glass, or a light transmissive plate such as an acrylic plate. In the present embodiment, the greenhouse may be so provided with the dye-sensitized solar cell modules 10 that light introducing parts 4 are located in the rear of the respective dye-sensitized solar cell modules 10.

The dye-sensitized solar cell module 10 may be that according to the example embodiment described above, and includes the plurality of cylindrical cells 1. The dye-sensitized solar cell module 10 has the configuration in which the cylindrical cells 1 are provided side-by-side laterally and separated away from one another. Hence, although each of the light introducing parts 4 on a roof or on a wall is covered with the dye-sensitized solar cell module 10, sunlight is allowed to pass through the clearance between the cylindrical cells 1 to enter the interior. The greenhouse according to the present embodiment is provided with a growth module 5. The growth module 5 utilizes electricity generated by the dye-sensitized solar cell module 10 for the growth of plants inside the greenhouse. In the present embodiment, the growth module 5 may be configured to perform a long-day adjustment. The wording “long-day adjustment” as used herein refers to adjustment to artificially lengthen the sunshine hours, which may be performed by allowing a long-hour light source provided in the greenhouse to be ON around sunrise or around sunset.

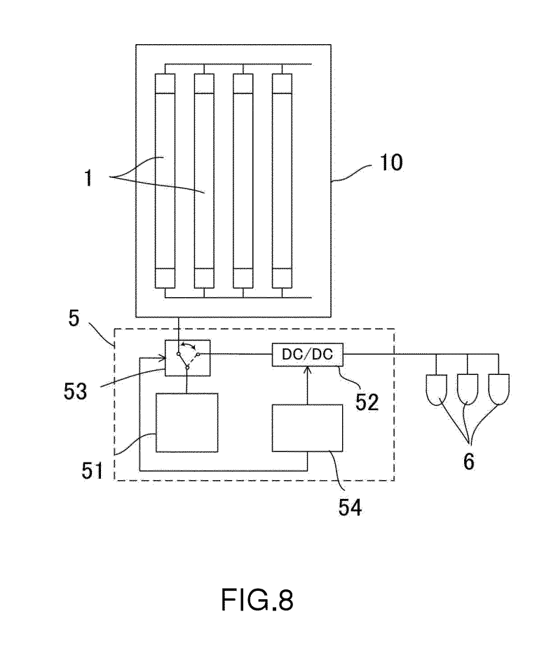

Referring to FIGS. 7 and 8, a description is provided below on the growth module 5. FIG. 8 illustrates a schematic configuration of the growth module 5 included in the greenhouse according to the present embodiment. The greenhouse according to the present embodiment may be provided therein with long-hour light sources 6. The long-hour light source 6 may include a white light-emitting diode (LED). As illustrated in FIG. 8, the growth module 5 may be provided with an electricity storage 51, a voltage adjuster 52, a switcher 53, a controller 54, and so forth. The electricity storage 51 stores therein the electricity generated by the dye-sensitized solar cell module 10. The voltage adjuster 52 adjusts a voltage supplied to the long-hour light sources 6. The switcher 53 switches between charge and discharge of the electricity storage 51. The controller 54 controls the voltage adjuster 52 and the switcher 53. In the present embodiment, the long-hour light source 6 may use LED and a DC/DC converter may be used for the voltage adjuster 52 accordingly. The voltage adjuster 52 may adjust an output voltage output from the electricity storage 51 to a direct-current (DC) voltage suitable for the long-hour light sources 6.

The controller 54 electrically connects each of the cylindrical cells 1 to the electricity storage 51 to charge electricity while disconnects an electrical connection between the long-hour light sources 6 and the electricity storage 51 during daytime. During nighttime, the controller 54 disconnects the electrical connection between the cylindrical cells 1 and the electricity storage 51, and electrically connects the electricity storage 51 to the long-hour light sources 6 to allow the long-hour light sources 6 to be ON during a partial period of time in the nighttime. The wording “partial period of time” as used herein may be a time period before the sunrise, after the sunset, or both, and may be set in advance in accordance with the long-hour adjustment to be performed. In some cases, however, the long-hour light sources 6 may be turned ON during a time period in which sunshine is little after the sunrise, a time period in which sunshine is little before the sunset, or both. The controller 54 is provided with a setting circuit or a memory in which a time period during which the long-hour light sources 6 are to be turned ON is set or stored in advance. The controller 54 controls the switcher 53 in accordance with the setting or stored information.

The electricity storage 51 may be a secondary battery such as a lithium-ion battery, a super capacitor such as an electrical double-layer capacitor, any other suitable charging device, or a combination of any charging devices including those mentioned above. Each of the cylindrical cells 1 may be electrically connected in series to take out electricity in many cases. However, the cylindrical cells 1 may be electrically connected in parallel in some cases.

In the greenhouse according to the present embodiment as described above, the electricity generated by the solar cells are used when performing the long-hour adjustment in accordance with grown plants, thus making it possible to save money on electricity. Here, because the cylindrical cells 1 are used, the conversion efficiency is higher than that of a case where a panel dye-sensitized solar cell is used, thus making it possible to perform the long-hour adjustment efficiently. In addition thereto, the cylindrical cells 1 are arranged to be separated away from one another. This allows for the introduction of light while providing the cylindrical cells 1 on a roof or on a wall, and allows for utilization of the scattered light entering the cylindrical cells 1 from the behind as well to further increase the conversion efficiency.

To merely perform solar power generation, it may be contemplated to provide a dye-sensitized solar cell module including panel dye-sensitized solar cells at open space near the greenhouse. However, because this results in requiring the space only for such a dye-sensitized solar cell module, this is infeasible unless there is enough room for the premises. In contrast, the greenhouse according to the present embodiment provides the dye-sensitized solar cell module 10 on a roof, a wall, etc., which allows for implementation of the dye-sensitized solar cell module 10 even when there is not enough room for the premises. Normally, placing a masking object like a solar cell on a roof or on a wall of a greenhouse has not been taken into consideration for the greenhouse from the viewpoint of introduction of light. The greenhouse according to the present embodiment, however, employs the dye-sensitized solar cell module 10 in which the cylindrical cells 1 are so disposed as to be separated away from one another, allowing the solar cell module to be installed on a roof or on a wall of a greenhouse contrary to common belief.

In each of the example embodiments described above, an orientation of each of the cylindrical cells 1 may be categorized into two arrangements when installing the dye-sensitized solar cell module 10 on a roof or on an exterior wall of a building. One of the arrangements may be an arrangement where the longitudinal direction of each of the cylindrical cells 1 is in a vertical direction as seen from the front, and the other may be an arrangement where the longitudinal direction of each of the cylindrical cells 1 is a horizontal direction as seen from the front. Both of the arrangements are the same in effect by which blocking by the adjacent cylindrical cell 1 is prevented to increase the conversion efficiency, but the vertical arrangement may be preferable from the viewpoint of preventing stain. More specifically, in the horizontal arrangement, attachment of stain or accumulation of dust may likely to occur on a top surface of each of the cylindrical cells 1. Such stain or dust may block sunlight to decrease the conversion efficiency accordingly. In the vertical arrangement, however, attachment of stain or accumulation of dust is difficult to occur. Also, such stain and dust are washed out easily by rainwater even if they are attached on the cylindrical cells 1. Hence, the blocking of sunlight by the stain or dust is less influential in the vertical arrangement than in the horizontal arrangement. FIGS. 6 and 7 each illustrate an example of the vertical arrangement as seeing the dye-sensitized solar cell module 10 from the side.

Although the invention has been described in the foregoing by way of example with reference to some example embodiments, the invention is not limited thereto but may be modified in a wide variety of ways.

Also, in each of the example embodiments described above, the term “cylindrical” is intended to be construed broadly to encompass, by way of example and without limitation, not only “cylindrical” in a strict geometrical sense but also “cylindrical” which is ellipse in cross section, as the concept of “cylindrical” used herein. In one embodiment of the invention where the cylindrical cell 1 having the elliptical cross-section is used, one of the expressions mentioned above may be applied for the upper limit and the lower limit of the separation spacing g, where a width of each of the cylindrical cells 1 in an array direction of the cylindrical cells 1 is defined as φ. Further, in each of the example embodiments described above, the cylindrical cells 1 are provided side-by-side laterally, although this is not limited to the case where the longitudinal directions of the respective cylindrical cells 1 are parallel to one another. The term “side-by-side” encompasses, byway of example and without limitation, intersection of longitudinal directions at a slight angle.

Furthermore, the invention encompasses any possible combination of some or all of the various embodiments described herein and incorporated herein.

It is possible to achieve at least the following configurations from the above-described example embodiments of the invention.

(1) A dye-sensitized solar cell module, including:

a plurality of cylindrical dye-sensitized solar cells each including a photoelectrode, a counter electrode, an electrolyte layer, and a cylindrical transparent tube, the photoelectrode having a dye, the electrolyte layer being provided between the photoelectrode and the counter electrode, and the transparent tube accommodating therein the photoelectrode, the counter electrode, and the electrolyte layer; and

one or more frames configured to retain the cylindrical dye-sensitized solar cells at positions that are side-by-side and separated away from one another.

(2) The dye-sensitized solar cell module according to (1), wherein the cylindrical dye-sensitized solar cells are retained by the single frame.
(3) The dye-sensitized solar cell module according to (1) or (2), wherein the following expression is satisfied:

0.3≦g/φ≦2

where φ is an outer diameter of each of the cylindrical dye-sensitized solar cells, and g is a spacing between one of the cylindrical dye-sensitized solar cells and adjacent one of the cylindrical dye-sensitized solar cells.

(4) The dye-sensitized solar cell module according to any one of (1) to (3), wherein the frame includes sockets configured to attachably and detachably retain each of the cylindrical dye-sensitized solar cells at both longitudinal ends of each of the cylindrical dye-sensitized solar cells.
(5) The dye-sensitized solar cell module according to any one of (1) to (4), wherein the cylindrical dye-sensitized solar cells have respective lengths that are same as one another, and
the frame is rectangular in shape.
(6) A greenhouse, including:

a housing;

a light introducing part provided entirely or partially on the housing;

the dye-sensitized solar cell module according to any one of (1) to (5), and provided to face the light introducing part; and

a growth module configured to utilize electricity generated by the cylindrical dye-sensitized solar cells for growth of a plant in the greenhouse.

(7) The greenhouse according to (6), wherein a longitudinal direction of each of the cylindrical dye-sensitized solar cells in the dye-sensitized solar cell module is in a vertical direction.
(8) The greenhouse according to (6) or (7), further including a long-hour light source provided therein,

wherein the growth module includes:

an electricity storage configured to store therein the electricity generated by the dye-sensitized solar cell module; and

a controller configured to supply the electricity stored in the electricity storage to the long-hour light source before sunrise, after sunset, or both, to allow the long-hour light source to be ON.

(9) A building, including:

a housing; and

a plurality of cylindrical dye-sensitized solar cells provided entirely or partially on the housing, and provided side-by-side and separated away from one another, a longitudinal direction of each of the cylindrical dye-sensitized solar cells being a vertical direction.

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. Moreover, no element or component in this disclosure is intended to be dedicated to the public regardless of whether the element or component is explicitly recited in the following claims.

What is claimed is:

1. A dye-sensitized solar cell module, comprising:
a plurality of cylindrical dye-sensitized solar cells each including a photoelectrode, a counter electrode, an electrolyte layer, and a cylindrical transparent tube, the photoelectrode having a dye, the electrolyte layer being provided between the photoelectrode and the counter electrode, and the transparent tube accommodating therein the photoelectrode, the counter electrode, and the electrolyte layer; and
one or more frames configured to retain the cylindrical dye-sensitized solar cells at positions that are side-by-side and separated away from one another.

2. The dye-sensitized solar cell module according to claim 1, wherein the cylindrical dye-sensitized solar cells are retained by the single frame.

3. The dye-sensitized solar cell module according to claim 1, wherein the following expression is satisfied:
0.3≦g/φ≦2
where φ is an outer diameter of each of the cylindrical dye-sensitized solar cells, and g is a spacing between one of the cylindrical dye-sensitized solar cells and adjacent one of the cylindrical dye-sensitized solar cells.

4. The dye-sensitized solar cell module according to claim 1, wherein the frame includes sockets configured to attachably and detachably retain each of the cylindrical dye-sensitized solar cells at both longitudinal ends of each of the cylindrical dye-sensitized solar cells.

5. The dye-sensitized solar cell module according to claim 1, wherein
the cylindrical dye-sensitized solar cells have respective lengths that are same as one another, and
the frame is rectangular in shape.

6. A greenhouse, comprising:
a housing;
a light introducing part provided entirely or partially on the housing;
a dye-sensitized solar cell module provided to face the light introducing part, and including a plurality of cylindrical dye-sensitized solar cells and one or more frames,
the cylindrical dye-sensitized solar cells each including a photoelectrode, a counter electrode, an electrolyte layer, and a cylindrical transparent tube, the photoelectrode having a dye, the electrolyte layer being provided between the photoelectrode and the counter electrode, and the transparent tube accommodating therein the photoelectrode, the counter electrode, and the electrolyte layer, and
the frame being configured to retain the cylindrical dye-sensitized solar cells at positions that are side-by-side and separated away from one another; and
a growth module configured to utilize electricity generated by the cylindrical dye-sensitized solar cells for growth of a plant in the greenhouse.

7. The greenhouse according to claim 6, wherein a longitudinal direction of each of the cylindrical dye-sensitized solar cells in the dye-sensitized solar cell module is in a vertical direction.

8. The greenhouse according to claim 6, further comprising a long-hour light source provided therein,
wherein the growth module includes:
an electricity storage configured to store therein the electricity generated by the dye-sensitized solar cell module; and
a controller configured to supply the electricity stored in the electricity storage to the long-hour light source before sunrise, after sunset, or both, to allow the long-hour light source to be ON.

9. A building, comprising:
a housing; and
a plurality of cylindrical dye-sensitized solar cells provided entirely or partially on the housing, and provided side-by-side and separated away from one another, a longitudinal direction of each of the cylindrical dye-sensitized solar cells being a vertical direction.
